(19) United States
(12) Patent Application Publication
(10) Pub. No.: US 2011/0272262 A1
(43) Pub. Date: Nov. 10, 2011

(54) LUMINOUS KEYBOARD

(75) Inventor: Bo-An Chen, Taipei (TW)

(73) Assignee: PRIMAX ELECTRONICS LTD., Taipei (TW)

(21) Appl. No.: 12/824,482

(22) Filed: Jun. 28, 2010

(30) Foreign Application Priority Data
May 7, 2010 (TW) 099114611

(51) Int. Cl. H01H 13/76

(52) U.S. Cl. 200/5 A; 200/310

(57) ABSTRACT

A luminous keyboard includes plural keys, a membrane circuit board, at least one light-emitting element and a base. The light-emitting element serves as a light source of the luminous keyboard. The base is used for supporting the plural keys, the membrane circuit board and the light-emitting element. At least one component of the membrane circuit board is made of light-guiding material, so that the membrane circuit board possesses a light-guiding function. That is, the luminous keyboard has simplified configurations and the overall thickness thereof is reduced.

### FIELD OF THE INVENTION

The present invention relates to a keyboard, and more particularly to a luminous keyboard.

### BACKGROUND OF THE INVENTION

Recently, with increasing development of information industries, portable information devices such as notebook computers or personal digital assistants are widely used in many instances. In a case that a portable information device is used in a dim environment, the numbers and texts marked on the keys of the keyboard of the portable information device are not clearly visible. In other words, the dim environment becomes hindrance from operating the keyboard. In addition, if the keyboard is used in the dim environment, the user is readily suffered from vision impairment. For solving these drawbacks, an illuminated keyboard has been disclosed. The illuminated keyboard could be used in the dim environment in order to enhance the applications thereof. Moreover, by changing the arrangement of luminous regions, the information device having the illuminated keyboard is more aesthetically-pleasing and thus the competitiveness thereof is enhanced.

FIG. 1 is a schematic cross-sectional view illustrating a luminous keyboard according to the prior art. As shown in FIG. 1, the luminous keyboard comprises a casing 10, a reflector 11, a light guide plate 12, a membrane circuit board 13, plural elastic members 14, plural keys 15 and plural light-emitting elements 16. The membrane circuit board 13 comprises a first flexible circuit board 131, a second flexible circuit 132, and a partition plate 133 between the first flexible circuit board 131 and the second flexible circuit 132. The first flexible circuit board 131, the second flexible circuit 132 and the partition plate 133 are made of transparent material. The transparent material includes for example polycarbonate (PC) or polyethylene (PE). The first flexible circuit board 131 has plural upper contact terminals 1311 corresponding to the plural keys 15. The second flexible circuit 132 has plural lower contact terminals 1321 corresponding to the plural keys 15. The partition plate 133 has plural perforations 1331 corresponding to the plural keys 15.

When any key 15 is pressed by a user, an upper contact terminal 1311 corresponding to the pressed key 15 is contacted with a corresponding lower contact terminal 1321 through a corresponding perforation 1331. As such, the upper contact terminal 1311 and the lower contact terminal 1321 corresponding to the pressed key 15 are electrically connected with each other, and the luminous keyboard 1 generates a key signal. The light-emitting elements 16 are arranged at bilateral sides of the light guide plate 12 for emitting light beams. The light beams are incident to the light guide plate 12. By the light guide plate 12, the light beams are uniformly and upwardly directed to the membrane circuit board 13, the elastic members 14 and the keys 15. As a consequence, the plural keys 15 have luminous efficacy. Moreover, for well utilizing the light beams provided by the light-emitting elements 16, the downward light beams incident to the light guide plate 12 are reflected by the reflector 11, so that the reflected light beams are also directed upwardly.

The conventional luminous keyboard, however, still has some drawbacks. For example, since the components of the conventional luminous keyboard are arranged in a multi-layer stack, the process of assembling the conventional luminous keyboard is very complicated. Due to so many components, it is difficult to reduce overall thickness of the conventional luminous keyboard. In other words, the conventional luminous keyboard fails to meet the requirement of slimness.

### SUMMARY OF THE INVENTION

It is an object of the present invention to provide a luminous keyboard having simplified configurations in order to reducing the fabricating cost and the keyboard thickness.

In accordance with an aspect of the present invention, there is provided a luminous keyboard. The luminous keyboard includes plural keys, a membrane circuit board, at least one light-emitting element and a base. Plural membrane switches are mounted on the membrane circuit board corresponding to the plural keys. The membrane circuit board includes a first flexible circuit board, a partition plate and a second flexible circuit board. The first flexible circuit board has a first circuit pattern with plural upper contact terminals. The partition plate has plural perforations. The second flexible circuit board has a second circuit pattern with plural lower contact terminals corresponding to the plural upper contact terminals and the plural perforations. The partition plate is sandwiched between the first flexible circuit board and the second flexible circuit board. At least one of the first flexible circuit board, the partition plate and the second flexible circuit board is made of light-guiding material. The light-emitting element serves as a light source of the luminous keyboard. The base is disposed under the membrane circuit board for supporting the plural keys, the membrane circuit board and the light-emitting element.

In an embodiment, the light-emitting element is arranged at a lateral edge of the second flexible circuit board or buried within the membrane circuit board.

In an embodiment, the light-emitting element is a light emitting diode for providing visible light beams.

In an embodiment, the light-emitting element is a light emitting diode for providing invisible light beams. In addition, a fluorescent agent is contained in the plural keys, the first flexible circuit board, the second flexible circuit board or the base for converting the invisible light beams into visible light beams.

In an embodiment, the base has a supporting surface, and the supporting surface is made of metallic mirror material for reflecting light beams that are provided by the light-emitting element.

In an embodiment, the first flexible circuit board is made of polyethylene terephthalate (PET).

In an embodiment, the light-guiding material is made of polycarbonate (PC) or polymethylmethacrylate (PMMA). Moreover, the first flexible circuit board, the partition plate or the second flexible circuit board which is made of light-guiding material has plural dots, so that light beams provided by the light-emitting element are guided by the dots.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating a luminous keyboard according to the prior art;

FIG. 2 is a schematic cross-sectional view illustrating a luminous keyboard according to an embodiment of the present invention;

FIG. 3 is an enlarged fragmentary view of the luminous keyboard as shown in FIG. 2;

FIG. 4 is a schematic three-dimensional exploded view illustrating the membrane circuit board of the luminous keyboard according to an embodiment of the present invention; and

FIG. 5 is a schematic view illustrating a second flexible circuit board of the luminous keyboard according to an embodiment of the present invention, in which the second flexible circuit board is made of light-guiding material.

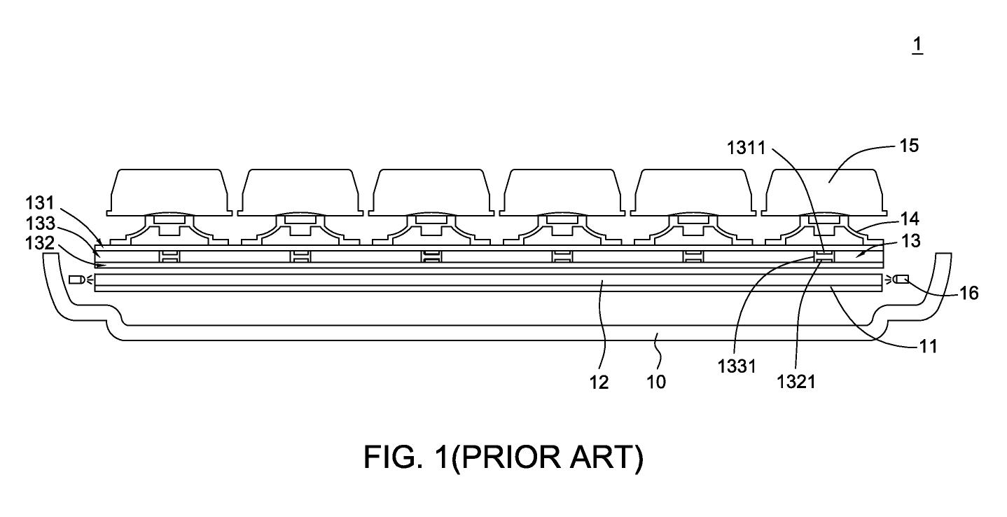

### DETAILED DESCRIPTION OF THE PREFERRED EMBODIMENT

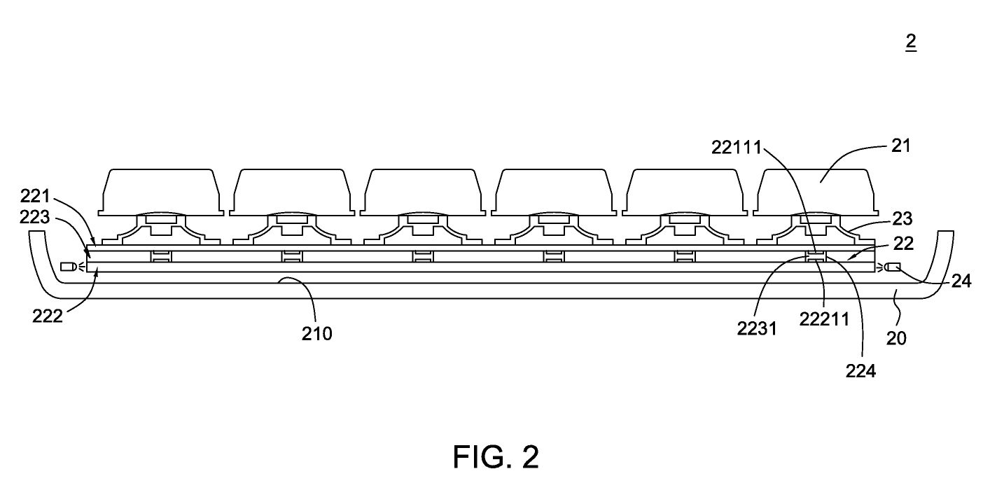

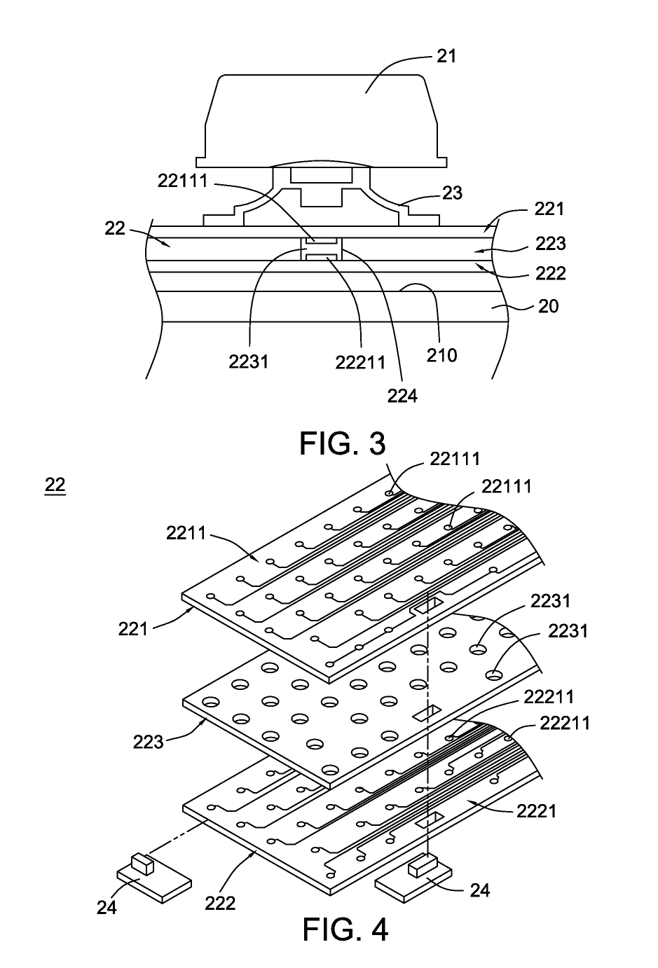

FIG. 2 is a schematic cross-sectional view illustrating a luminous keyboard according to an embodiment of the present invention. FIG. 3 is an enlarged fragmentary view of the luminous keyboard as shown in FIG. 2. Please refer to FIGS. 2 and 3. The luminous keyboard 2 comprises a base 20, plural keys 21, a membrane circuit board 22, plural elastic members 23 and at least one light-emitting element 24. The membrane circuit board 22 comprises a first flexible circuit board 221, a second flexible circuit board 222 and a partition plate 223. The partition plate 223 is sandwiched between the first flexible circuit board 221 and the second flexible circuit board 222.

FIG. 4 is a schematic three-dimensional exploded view illustrating the membrane circuit board of the luminous keyboard according to an embodiment of the present invention. The first flexible circuit board 221 has a first circuit pattern 2211. The first circuit pattern 2211 has plural upper contact terminals 22111 corresponding to the plural keys 21. The second flexible circuit board 222 has a second circuit pattern 2221. The second circuit pattern 2221 has plural lower contact terminals 22211 corresponding to the plural keys 21. The plural upper contact terminals 22111 and the plural lower contact terminals 22211 are separated from each by the partition plate 223. The partition plate 223 has plural perforations 2231 corresponding to the plural upper contact terminals 22111 and the plural lower contact terminals 22211. Moreover, the plural upper contact terminals 22111, the plural lower contact terminals 22211 and the plural perforations 2231 collective define plural membrane switches 224, which are arranged at the positions corresponding to respective keys 21.

When any key 21 is pressed by a user, an upper contact terminal 22111 corresponding to the pressed key 21 is contacted with a corresponding lower contact terminal 22211 through a corresponding perforation 2231. As such, the upper contact terminal 22111 and the lower contact terminal 22211 corresponding to the pressed key 21 are electrically connected with each other, and the luminous keyboard 2 generates a key signal. The base 20 is disposed under the membrane circuit board 22. The base 20 has a supporting surface 210 for supporting the plural keys 21, the membrane circuit board 22 and the light-emitting element 24. The elastic members 23 are arranged between the plural keys 21 and the membrane circuit board 22 for providing elastic forces. In response to the elastic forces, the pressed key 21 is restored to the original position after the pressing force is eliminated.

Moreover, all of the first flexible circuit board 221, the second flexible circuit board 222 and the partition plate 223 are made of plastic material. In an embodiment, any one of the first flexible circuit board 221, the second flexible circuit board 222 and the partition plate 223 is made of light-guiding material. Alternatively, all of the first flexible circuit board 221, the second flexible circuit board 222 and the partition plate 223 are made of light-guiding material.

Preferably, the first flexible circuit board 221 is made of polyethylene terephthalate (PET), and the second flexible circuit board 222 is made of light-guiding material such as polycarbonate (PC) or polymethylmethacrylate (PMMA).

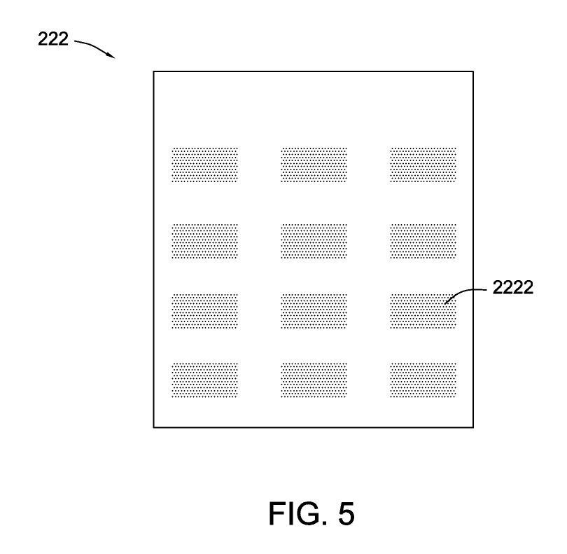

FIG. 5 is a schematic view illustrating a second flexible circuit board of the luminous keyboard according to an embodiment of the present invention, in which the second flexible circuit board is made of light-guiding material. The light-guiding material has high reflectivity but no light absorption. In this embodiment, the second flexible circuit board 222 is made of light-guiding material, and plural dots 222 are formed on the second flexible circuit board 222 for guiding the light beams that are provided by the light-emitting element 24. According to specific arrangement design of the plural dots 2222, the optical characteristics of the second flexible circuit board 222 are improved. For example, high luminance and light uniformity are achieved. The method of placing the plural dots 2222 on proper positions are known in the art, and is not redundantly described herein.

Moreover, the light-emitting element 24 is used as a light source of the luminous keyboard 24. The light-emitting element 24 is arranged at a lateral edge of the second flexible circuit board 222 or buried within the membrane circuit board 22. When the light beams are incident to the second flexible circuit board 222, by the second flexible circuit board 222, the light beams are uniformly and upwardly directed to the first flexible circuit board 221, the elastic members 23 and the plural keys 21. As a consequence, the key 21 has luminous efficacy. That is, when the luminous keyboard 2 is used in a dim environment, the user may accurately press desired keys, and the possibility of erroneously pressing keys will be minimized.

In this embodiment, the light-emitting element 24 is a light emitting diode for providing visible light beams. Alternatively, the light-emitting element 24 is a light emitting diode for providing invisible light beams. In a case that the light-emitting element 24 is a light emitting diode for providing invisible light beams, a fluorescent agent is contained in the plural keys (e.g. in the symbol regions), the second flexible circuit board 222 (e.g. in the regions of the plural dots), the second flexible circuit board 221 or the base 20. By the fluorescent agent, the invisible light beams provided by the light-emitting element 24 could be converted into visible light beams. In accordance with this method, the problem of causing light leakage problem will be largely reduced because the light intensity is not very strong to leak out of the non-luminous regions. In this situation, the efficacy of utilizing the light beams is enhanced.

Moreover, for well utilizing the light beams provided by the light-emitting element 24, the supporting surface 210 is preferably made of metallic material sufficient for providing mirror efficacy. As such, the leaked downward light beams may be reflected by the supporting surface 210, and the reflected light beams are also directed upwardly to the membrane circuit board 22, the elastic members 23 and the plural keys 21.

It is noted that, since any one of the first flexible circuit board 221, the second flexible circuit board 222 and the partition plate 223 is made of light-guiding material, the membrane circuit board 22 possesses a light-guiding function. That is, the light guide plate used in the conventional luminous keyboard could be exempted from the luminous keyboard of the present invention. In this situation, the luminous keyboard 2 has simplified configurations and the overall thickness thereof is reduced. In addition, the process of assembling the luminous keyboard 2 is simplified and the fabricating cost is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A luminous keyboard, comprising:
plural keys;
a membrane circuit board, wherein plural membrane switches are mounted on said membrane circuit board corresponding to said plural keys, and said membrane circuit board comprises:
a first flexible circuit board having a first circuit pattern with plural upper contact terminals;
a partition plate having plural perforations; and
a second flexible circuit board having a second circuit pattern with plural lower contact terminals corresponding to said plural upper contact terminals and said plural perforations, wherein said partition plate is sandwiched between said first flexible circuit board and said second flexible circuit board, wherein at least one of said first flexible circuit board, said partition plate and said second flexible circuit board is made of light-guiding material;
at least one light-emitting element serving as a light source of said luminous keyboard; and
a base disposed under said membrane circuit board for supporting said plural keys, said membrane circuit board and said light-emitting element.

2. The luminous keyboard according to claim 1 wherein said light-emitting element is arranged at a lateral edge of said second flexible circuit board or buried within said membrane circuit board.

3. The luminous keyboard according to claim 1 wherein said light-emitting element is a light emitting diode for providing visible light beams.

4. The luminous keyboard according to claim 1 wherein said light-emitting element is a light emitting diode for providing invisible light beams, and a fluorescent agent is contained in said plural keys, said first flexible circuit board, said second flexible circuit board or said base for converting said invisible light beams into visible light beams.

5. The luminous keyboard according to claim 1 wherein said base has a supporting surface, and said supporting surface is made of metallic mirror material for reflecting light beams that are provided by said light-emitting element.

6. The luminous keyboard according to claim 1 wherein said first flexible circuit board is made of polyethylene terephthalate (PET).

7. The luminous keyboard according to claim 1 wherein said light-guiding material is made of polycarbonate (PC) or polymethylmethacrylate (PMMA), wherein said first flexible circuit board, said partition plate or said second flexible circuit board which is made of light-guiding material has plural dots, so that light beams provided by said light-emitting element are guided by said dots.
